(19) United States
(12) Patent Application Publication
(10) Pub. No.: US 2025/0029019 A1
(43) Pub. Date: Jan. 23, 2025

(54) THE QUIET WORKPLACE SYSTEM

(71) Applicant: The Sheffield Company, LLC, Southern Pines, NC (US)

(72) Inventor: Joseph McCormack, Southern Pines, NC (US)

(21) Appl. No.: 18/775,903

(22) Filed: Jul. 17, 2024

Related U.S. Application Data
(60) Provisional application No. 63/527,245, filed on Jul. 17, 2023.

(51) Int. Cl. G06Q 10/02; E04H 1/12

(52) U.S. Cl. CPC G06Q 10/02; E04H 1/125

(57) ABSTRACT

A system and method for providing, protecting, and promoting quiet in the workplace is presented. Utilizing specially designed pods arranged in a protected quite workplace environment, users can schedule dedicated quiet work time for increased focus and attention away from distraction. Access to the quiet workplace environment may be managed by a smart reservation system that can actively manage reservation times and durations to stagger access to the environment and assign users to various pods in the environment such that interactions among users in the environment is minimized or eliminated, thereby further promoting focused, distraction free work time.

### PRIORITY

This application claims priority to U.S. Provisional Patent Application No. 63/527,245 filed Jul. 17, 2023, the entirety of which is incorporated herein by reference.

### FIELD OF THE INVENTION

The present disclosure relates to, among other things, systems and methods designed to increase the productivity and thinking power of individuals. More particularly, the present disclosure relates to systems and methods for minimizing audio and visual distractions in a work environment.

### BACKGROUND

Modern work environments are often full of distractions and noise (i.e., both audio and visual distractions). The collaboration and other benefits of working in group settings are often vital in many respects for operating teams and/or businesses, but extremely detrimental in those instances when deep thought or focus is required. People interrupt, phones ring, conversations of others distract, all subtracting from the focus an individual may require for certain tasks. These distractions and noise, and the negative impact on productivity they can create, leave individuals feeling overwhelmed and unfulfilled at their places of work.

For example, FIG. 1 depicts a typical “open office” configuration common today. In this example, open office 100 includes an open area 110 that includes a number of open cubicles 115 distributed throughout. One or more conference rooms (e.g., conference room 120) may be included in open office 100, as well as one or more individual offices 130 for managers, etc. Such “open office” configurations may advantageously allow for collaboration at any moment, but disadvantageously provide for many distractions, zero privacy or quiet time, and effectively an “always-on” atmosphere.

Some have tried to provide solutions for these problems, but none have adequately solved the problem. One solution called CaveDay, for example, is generally an online, moderated event that promotes concentration and productivity. But CaveDay's solution is not a physical work environment but an online solution, and also involves moderators that can leave participants feeling overly watched and judged as they complete their tasks—typically by moderators that lack an understanding of the work and/or goal the participant is trying to complete or achieve.

Other shared workspace solutions, such as for example We Works, Breather, or Liquid Space, attempt to provide productive collaborative environments, but such solutions are often ineffective for tasks that require individual, focused attention without outside distraction.

What is needed is a solution that can be implemented in existing office environments, for example, where day to day operations of the business may be conducted in groups or otherwise in a manner that may necessarily include noise and distractions, but nevertheless provide a separate space for one or more individuals to complete focused work. This solution may include a specialized focus area or floor that includes, among other things, sound masking technology, a reservation system that enables individuals to access the space in a manner that minimizes or eliminates interactions with others, an individualized work space designed to allow minimal visual distractions from the outside, and/or various assessment and training tools to ensure all users of the space or environment are aware of and practicing techniques conducive to the quiet and focused strategies being employed. Such solutions may also be manufacturable and scalable such that existing office environments can quickly and efficiently implement such systems.

### SUMMARY

The present disclosure relates generally, in some embodiments, to a system for minimizing workplace distractions. The system may include a work pod area that includes a plurality of work pods available for use by a plurality of users. The system may also include a reservation system for managing appointments for use of the work pods by the plurality of users. In some embodiments, the reservation system may stagger access to the work pod area by the plurality of users such that users avoid interactions with other users upon entry and exit from the work pod area. The reservation system may also manage each user's work pod assignment to minimize a subsequent user from having to travel past an occupied work pod.

In some cases, the work pod area may include a separate entry and exit. The system may also include a check-in area for staging the plurality of users. Users may, in some embodiments, interface with a reservation system that may be accessible via a kiosk and/or other interface (e.g., over a network, via cell phone, etc.).

The system may maintain appointments and the work pod area may be accessible only by appointment. Appointments may also be for a specific time and duration. Time remaining in an appointment may be communicated to a user, for example, via a monitor or other display in the work pod (or elsewhere).

Work pods of the system may include dimmable lighting controlled by the user assigned to the work pod. Work pods may also include a desk area and chair, and/or a rest area that may include, among other things, a lounge chair. In some embodiments, the work pod may include an entryway, and the desk area may be positioned such that the user of the work pod faces away from the entryway when using the desk.

In some embodiments, the current disclosure may also relate to a method of minimizing workplace distractions during focused work. The method may include providing a work pod area comprising a plurality of work pods that are available for set appointments of limited duration. A plurality of users may be enabled to reserve individual appointments for use of the work pods in a reservation system. The reservation system may actively manage the appointments and work pod assignments for the plurality of users to enable staggered access by the users to the work pod area and disbursement of work pod assignments for each user such that interactions among users during ingress and egress is minimized.

### BRIEF DESCRIPTION OF THE DRAWINGS

FIG. 1 is an exemplary schematic of a collaborative work environment typical in the prior art.

FIG. 2A is an exemplary schematic of one aspect of the quiet workplace environment of the present disclosure.

FIG. 2B is an exemplary schematic of another workplace environment combining an open collaborative environment with a quiet workplace environment of the present disclosure.

FIG. 3A is an exemplary exterior view of a pod according to one aspect of the present disclosure.

FIGS. 3B-3C are exemplary interior views of a pod according to one aspect of the present disclosure.

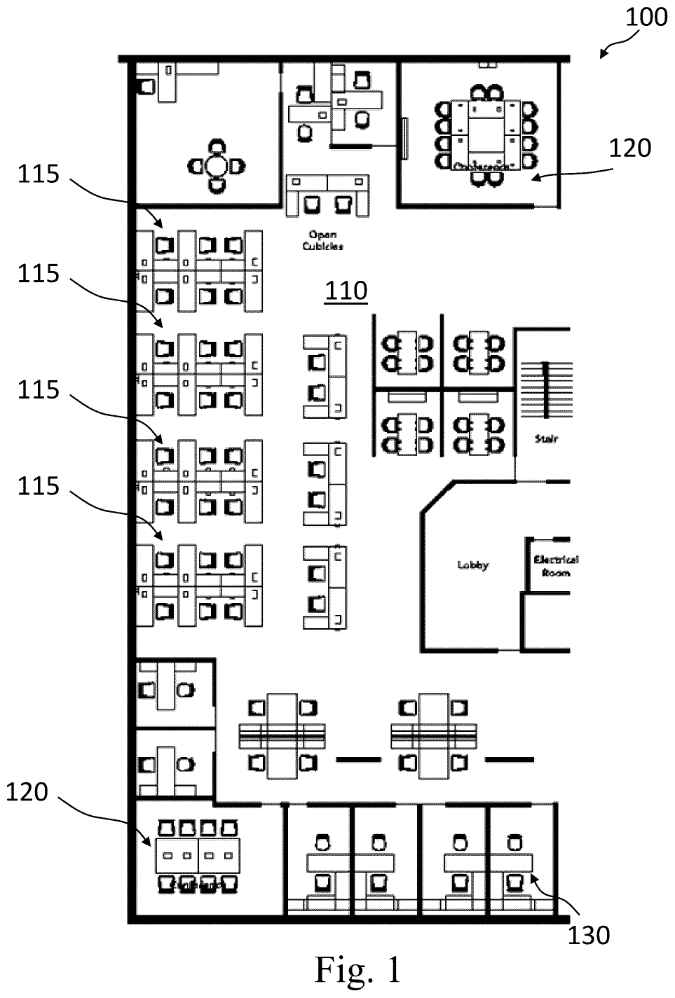

### DETAILED DESCRIPTION

Disclosed are various systems and methods for providing a work environment conducive to increasing productivity in the workplace, particularly an increase in the focus and thinking power of individuals. In some embodiments, the systems and methods may include a plurality of individual workspaces designed to minimize audio and visual distractions, a reservation system for intelligently scheduling and assigning individuals to respective workspaces to minimize or eliminate interactions with other individuals in the environment, and training and assessment tools for ensuring that individuals know and practice certain principles to minimize distractions (for themselves and others) and maximize productivity.

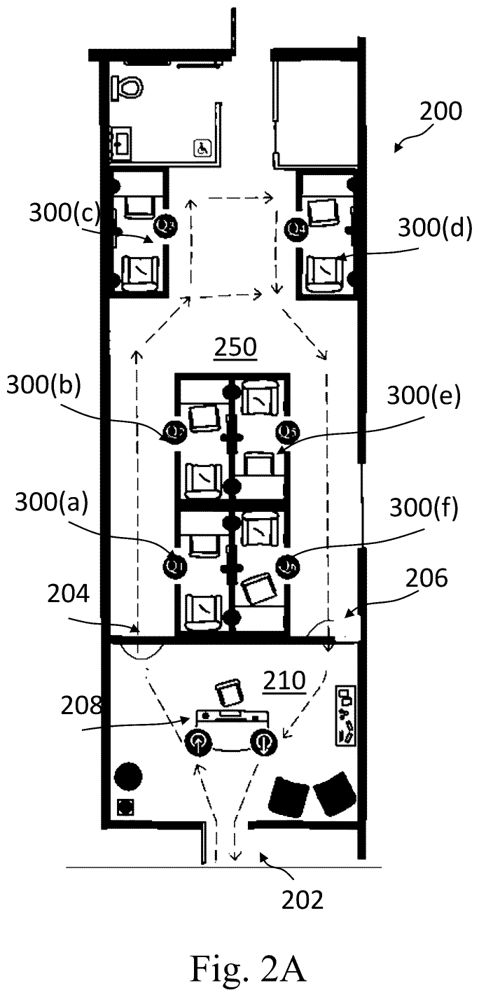

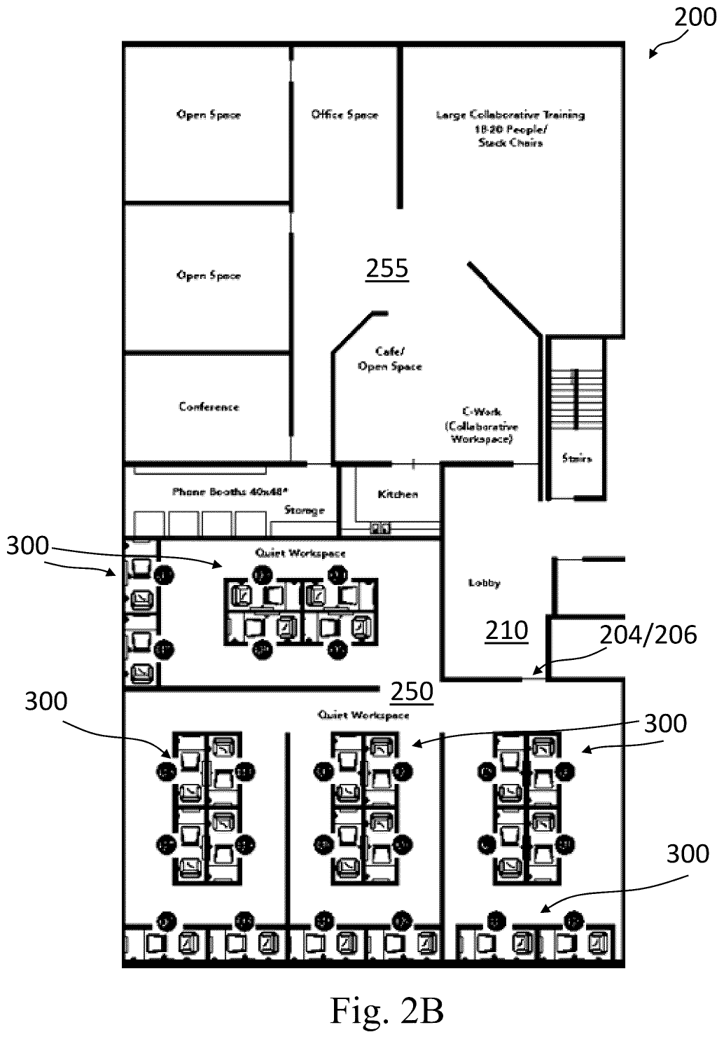

Referring now to FIG. 2A, an exemplary quiet workplace environment 200 according to some aspects of the present disclosure is presented. In some embodiments, environment 200 may include an entry lobby 210 and a quiet workspace portion 250. In some embodiments, lobby 210 may include a main entrance 202. The lobby 210 may also include a workspace portion entrance 204 and a workspace portion exit 206 (though in some embodiments entrance 204 and exit 206 may be a single entry/exit point). Lobby 210 may include, in some embodiments, a check-in kiosk 208, which may be any electronic kiosk (iPad, computer, etc.), or a live receptionist or other greeter may be utilized in combination with a computer or other kiosk. Lobby 210 may also include materials (posters, placards, brochures, etc.) outlining rules, practices and/or other procedures for the environment, including materials that align with the assessment and training tools (discussed hereinbelow).

The environment 200 may also include one or more individual pods 300, depicted for example in FIG. 2A as pods 300(a)-300(f) in workspace portion 250. Pods 300 may be permanent fixtures in workspace portion 250 or configured as movable, collapsible, or otherwise transportable modules. Pods 300 may be configured in any manner to maximize productivity for individuals, and may be customizable depending on, for example, the type of work to be completed, location, etc.

FIG. 2B presents an alternative workplace environment 200 illustrating a broader office environment that may include open, collaborative spaces 255 in combination with a quite workspace portion 250. Quite workspace portion 250 may similarly include a plurality of pods 300. In this example, pods 300 are clustered in groups of four as well as spread along the perimeter, but any desired configuration could be utilized. The exemplary configuration in FIG. 2B may also include a lobby 210 and an entry/exit door 204/206, though separate entrance and exit doors are similarly contemplated.

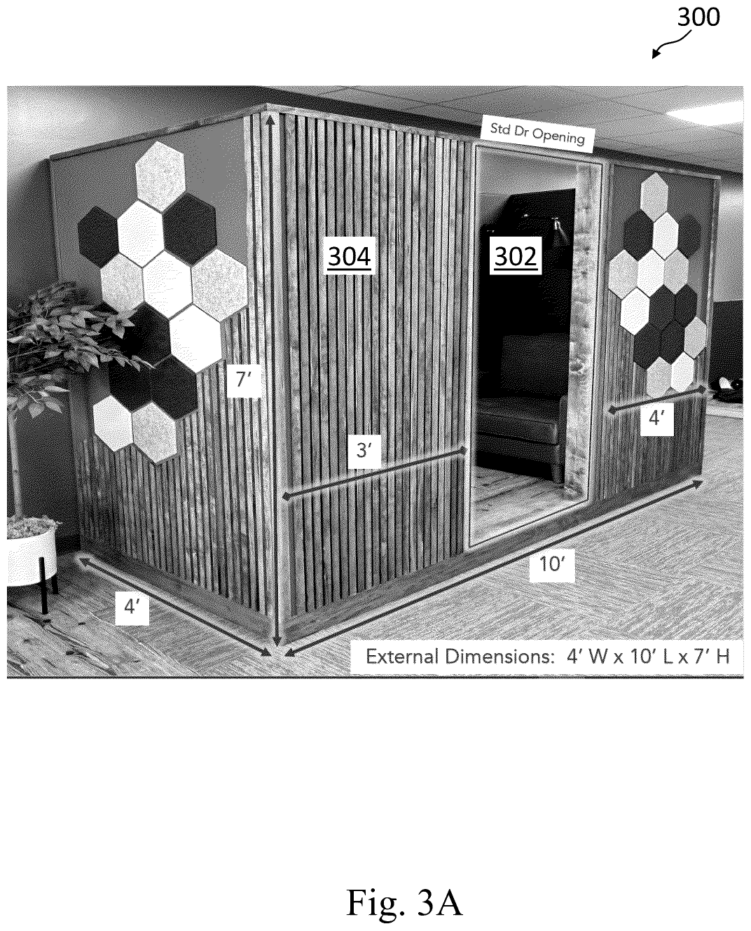

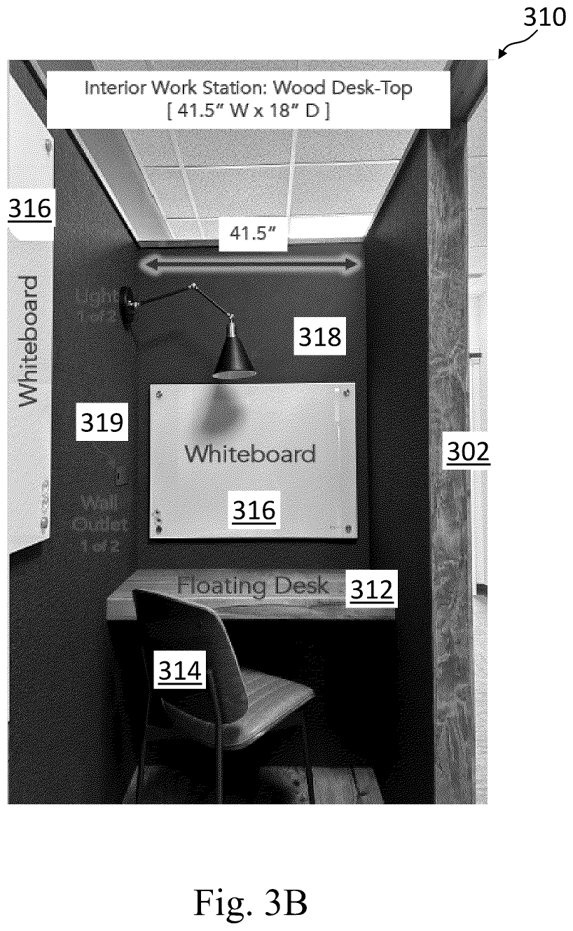

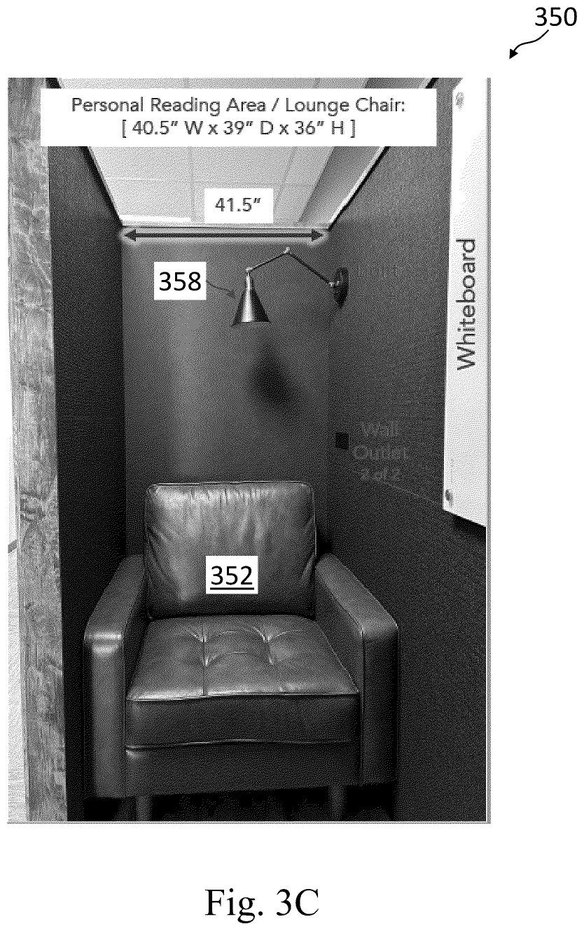

In one exemplary embodiment, referring now to FIGS. 3A-3C, pod 300 may be a generally rectangular pod (though any shape may be utilized) having an opening 302 and walls 304. In some embodiments, opening 302 may be located generally in a center of the pod 300. Pod 300 may have an open roof or include a ceiling as desired. Pod 300 may also optionally include an elevated floor or utilize the floor of the environment generally, as desired. It will be appreciated by those of skill in the art that all dimensions identified herein and/or in the Figures (including FIGS. 3A-3C) are exemplary only and are not intended to be limiting.

As illustrated for example in FIG. 3B, a first end of pod 300 may include a desk area 310. In some embodiments, the desk area 310 may include a desk 312. Other features of the first end of pod 300 may further include various lighting, one ore more white boards, one or more power outlets, a desk chair, and other features.

In some embodiments, and referring now to FIG. 3C, pod 300 may include a second end that includes a break out area 350. Break out area 350 may include, for example, a chair or other similar furniture. In some embodiments, pod 300 may also include any other appropriate furniture or equipment for the work to be performed, including whiteboards, work boards, magnetic boards, open space, additional and/or specialized lighting, etc.

In one preferred exemplary embodiment, shown for example in FIG. 3A, pod 300 may have dimensions generally of approximately 4′ by 10′, with a standard sized door opening 302 generally in the center of the long side. In this preferred exemplary embodiment, pod 300 may have walls approximately 7′ feet high. In this preferred exemplary embodiment, each pod 300 may have an approximate floor area of about 40 ft². In some embodiments, spacing between pods 300 is desired to further mitigate against noise distractions, etc. Thus, in some embodiments, the effective area required for each pod 300 may be approximately 70 ft² with the necessary buffer space in place. Pods 300 may also be arranged immediately adjacent one another if desired.

In certain preferred exemplary embodiments, shown for example in FIG. 3B, desk area 310 and desk 312 may include a floating desk, a desk chair 314, one or more whiteboards 316, lighting 318, and one or more power outlets 319. Desk 312 may have approximate dimensions of 41.5″ W×18″ D, though any appropriate size may be utilized.

In some embodiments, shown for example in FIG. 3C, rest area 350 may include lounge chair 352, and additional lighting 358, among other items appropriate for the space depending on the work to be completed.

One of ordinary skill in the art will appreciate, however, that any dimensions for pod 300 may be utilized depending on the environment and work to be performed, manufacturing and/or installation techniques desired to be employed, among other things, and the exemplary embodiments herein are not intended to be limiting.

In some embodiments, environment 200 may also include a computerized reservation system for scheduling individuals in the environment and intelligently managing ingress and egress from the quiet workplace environment 250. In some embodiments, the reservation system may be accessed by or generally run on or by kiosk 208. The reservation system may utilize artificial intelligence and other techniques to not just manage scheduling of the pods 300, but also intelligently manage assignment of pods 300 to individual users in a manner that further minimizes distractions to all individuals in the quiet workplace environment 250.

In some embodiments, upon arrival to environment 200, an individual may check-in with kiosk 208 to confirm their arrival for a pre-arranged appointment, or to make an appointment or otherwise book a time in environment 250. Depending on availability, among other things, kiosk 208 may schedule a time in the environment for the individual, provide instructions to the individual regarding details of the individual's appointment (for example, entry time, pod assignment, etc.), or other information. In some embodiments, lobby 210 may include a monitor, board or other display mechanism to communicate to individuals regarding entry/exit times, pod assignments, etc. Individuals may also access such information through other means such as via cell phone app, text message, email, or the like.

For example, in some embodiments, the reservation system may schedule a first individual for 8 am to 10 am. The first individual may then enter lobby 210 at approximately 8 am, and check-in with kiosk 208. Knowing that all pods are available, and also having awareness of the remaining schedule for the day, the reservation system may then assign the first individual to the pod 300 that minimizes interactions with other individuals to come later. The first individual may then be given access to the quiet workspace portion 250 at the time assigned by the reservation system. Access may be granted, for example, by utilizing a key card, fob, electronic lock release, or other appropriate mechanism for controlling entry into the workspace portion 250.

For example, with reference to FIG. 2A, if the first individual is the first individual to arrive on a given workday, then the reservation may assign the first individual to pod 300(f). At the appropriate time, the individual may be given access to workplace portion 250. The workplace environment may also be arranged to optimize traffic flow to minimize interactions. For example, as illustrated in FIG. 2A, entrance 204, pods 300, and exit 206 may be arranged to provide for a traffic flow that minimizes or eliminates repeated interactions by individuals with pods 300. Such flows may take any number of different paths, but in general will move people through quiet workspace portion 250 with minimal interactions with others. Quiet workplace portion 250 may include one or more indicators (active and/or passive) such as arrows, monitors, lighting or other communications mechanisms to instruct individuals how to move through the quiet workplace portion 250. Utilizing such mechanisms, for example, the first individual may be guided to the assigned pod (in this example, pod 300(f)).

Continuing this example, a second individual, scheduled for example from 8:30 to 10:30, may be assigned to pod 300(d). As before, the second individual may be given access to quiet workspace portion 250 at the appropriate time, and guided or otherwise directed to pod 300(d).

In this example, the first individual arrives and is directed to pod 300(f) without walking by any other individuals in other pods (because no pods are occupied at this point). The first individual completes his or her work in pod 300(f) without distraction, and later departs at 10 am. During that time, the second individual arrives at 8:30 and is directed to pod 300(d) (i.e., without having to walk by or otherwise interact with pod 300(f)). By the time the second individual is scheduled to leave at 10:30, the first individual has already departed and neither individual has any interaction with the other.

Utilizing artificial intelligence and other mechanisms, the reservation system can eliminate or at least minimize instances of individuals walking by occupied pods 300. While such instances cannot always be avoided, particularly as more pods 300 are introduced into workspace portion 250 and/or more users utilize the space, the reservation system can stagger and space reservations, and assign individuals to pods 300 in a manner that minimizes such interactions, thereby minimizing distractions. Pod assignments may also be arranged to minimize assignment of adjacent pods when non-adjacent pods are available.

Pods 300 may also be equipped with monitors, signs, or other mechanisms for communicating remaining time in reservation, and advise individuals of when pods must be vacated at close of reservation time, etc. Monitors or other devices may also enable communication with individuals whereby the individual may request additional time, or make other requests. Such communications may also be facilitated through the individuals cell phone, tablet, computer, etc., as desired.

The systems and methods disclosed herein may also utilize various training and assessment techniques to ensure individuals accessing the environment 200 are equipped to best utilize the environment and minimize distractions of themselves and others. For example, environment 200 may be introduced in some embodiments to an existing organization's workspace for use by one or more teams of the organization. In such embodiments, training may include a first team orientation course (either live or online, for example) where aspects of using and interacting with environment 200 are taught to team members. This includes how to utilize the reservation system, how to enter/exit quiet workplace portion 250, how to best utilize pod 300 and the time therein, etc.

Other training may include training sessions for group leaders or managers to help best encourage team members to utilize the space, and how to balance time in quiet workplace portion 250 with time spent in other workplace activities (e.g., in collaborative spaces 255 doing group collaboration, meetings, etc.). Training and assessment may also include debrief sessions following use where best practices may be identified and shared.

Training may also include various other quiet workplace techniques, including for example techniques for minimizing or eliminating use of screens for certain activities, reclaiming space, daily best practices, etc.

The disclosures herein may be embodied in other specific forms without departing from the spirit or essential characteristics thereof. The present embodiments are therefore to be considered in all respects as illustrative and not restrictive, the scope of the disclosure being indicated by the claims of the application rather than by the foregoing description, and all changes which come within the meaning and range of equivalency of the claims are therefore intended to be embraced therein.

The terminology used herein is for the purpose of describing particular embodiments only and is not intended to be limiting of the approach. As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the foregoing description references certain preferred embodiments, other embodiments are possible. Additionally, the foregoing illustrative embodiments, examples, features, advantages, and attendant advantages are not meant to be limiting, as the devices, systems, and methods disclosed herein may be practiced according to various alternative embodiments, as well as without necessarily providing, for example, one or more of the features, advantages, and attendant advantages that may be provided by the foregoing illustrative embodiments.

Accordingly, while devices, systems, and methods have been described and illustrated in connection with preferred embodiments, many variations and modifications as will be evident to those skilled in the art may be made without departing from the scope of the present approach, and the claims should not be limited to the precise details of methodology or construction set forth above, as such variations and modifications are intended to be within the scope of the claims.

1. A system for minimizing workplace distractions, the system comprising:
a work pod area comprising a plurality of work pods available for use by a plurality of users, and
a reservation system for managing appointments for use of the work pods by the plurality of users,
wherein the reservation system staggers access to the work pod area by the plurality of users such that users avoid interactions with other users upon entry and exit from the work pod area,
and further wherein the reservation system manages each user's work pod assignment to minimize instances of a subsequent user from having to travel past an occupied work pod.

2. The system of claim 1, wherein the work pod area comprises a separate entry and exit.

3. The system of claim 1, further comprising a check-in area for staging the plurality of users.

4. The system of claim 3, wherein the check-in area further comprises a kiosk where users interface with the reservation system.

5. The system of claim 1, wherein the work pod area is accessible by appointment only.

6. The system of claim 5, wherein the appointments are limited to a set time and duration.

7. The system of claim 6, wherein the work pod further comprises a display for communicating remaining appointment time to the user.

8. The system of claim 1, wherein the reservation system is accessible to the plurality of users over a network.

9. The system of claim 1, wherein each work pod comprises dimmable lighting controlled by the user assigned to the work pod.

10. The system of claim 1, wherein each of the work pods comprise a desk area and a chair.

11. The system of claim 10, wherein the work pod comprises an entryway, and the desk area is positioned such that the user of the work pod faces away from the entryway when using the desk.

12. The system of claim 10, wherein each of the work pods comprise a rest area separate from the desk area.

13. The system of claim 12, wherein the rest area comprises a lounge chair.

14. A method of minimizing workplace distractions during focused work, the method comprising:
providing a work pod area comprising a plurality of work pods, wherein the work pods are available for set appointments of limited duration;
enabling a plurality of users to reserve individual appointments in a reservation system;
wherein the reservation system actively manages the appointments and work pod assignments to enable staggered access by the users to the work pod area and disbursement of work pod assignments for each user such that interactions among users during ingress and egress is minimized.

15. The method of claim 14, wherein management of the appointments includes limiting appointments to specific times and durations.

16. The method of claim 14, further comprising the step of providing a display for communicating remaining appointment time to the user.

17. The method of claim 14, wherein the reservation system is accessible to the plurality of users over a network.

18. The method of claim 14, wherein each of the work pods comprise a desk area and a chair.

19. The method of claim 18, wherein each of the work pods comprise an entryway, and the desk area of each pod is positioned such that the user of the work pod faces away from the entryway of the pod when using the desk.

20. The method of claim 18, wherein each of the work pods a rest area separate from the desk area.
